(19) United States
(12) Patent Application Publication
(10) Pub. No.: US 2021/0065656 A1
(43) Pub. Date: Mar. 4, 2021

(54) CONTROL METHOD, DETECTION DEVICE, AND DISPLAY DEVICE

(71) Applicant: SEIKO EPSON CORPORATION, Tokyo (JP)

(72) Inventor: Keisuke HIGASHI, Azumino-shi (JP)

(73) Assignee: SEIKO EPSON CORPORATION, Tokyo (JP)

(21) Appl. No.: 17/003,375

(22) Filed: Aug. 26, 2020

(30) Foreign Application Priority Data
Aug. 27, 2019 (JP) 2019-154413

(51) Int. Cl. G09G 5/10; H04N 9/31

(52) U.S. Cl. CPC G09G 5/10; G09G 2360/141; G09G 2360/145; H04N 9/312

(57) ABSTRACT

A control method of controlling an emission direction of light emitted toward a display surface to be executed by a detection device configured to include an emission section and detect an irradiation position of the light includes the steps of determining whether or not the irradiation position of the light in the display surface is located in a target area, controlling the emission direction of the light to a direction of moving the irradiation position toward the target area when determining that the irradiation position is not located in the target area, and sets an amount of movement of the irradiation position toward the target area by control of the emission direction of the light larger when the irradiation position is located in a first region compared to when the irradiation position is located in a second region between the target area and the first region.

The present application is based on, and claims priority from JP Application Serial Number 2019-154413, filed Aug. 27, 2019, the disclosure of which is hereby incorporated by reference herein in its entirety.

### BACKGROUND

### 1. Technical Field

The present disclosure relates to a control method, a detection device, and a display device.

### 2. Related Art

In JP-A-2018-164251 (Document 1), there is described a device which emits light in a planar fashion so as to cover a projection image on a display surface, and then detects a position of a pointing body based on a reflection position of the light by the pointing body on the display surface.

This device adjusts an emission direction of the light using imaging data generated by imaging the display surface so that the irradiation position of the light emitted in a planar fashion in the display surface is located in a target area.

In the device described in Document 1, when repeating an operation of moving the irradiation position as much as a given distance when the irradiation position is not located in the target area, it takes time until the irradiation position reaches the target area.

### SUMMARY

A control method according to an aspect of the present disclosure is a method of controlling an emission direction of light emitted from an emission section toward a display surface to be executed by a detection device configured to include the emission section and detect an irradiation position of the light, the method including the steps of determining whether or not the irradiation position of the light in the display surface is located in a target area based on imaging data generated by imaging the display surface, controlling the emission direction of the light to a direction of moving the irradiation position toward the target area when determining that the irradiation position is not located in the target area, and setting an amount of movement of the irradiation position toward the target area by control of the emission direction of the light larger when the irradiation position is located in a first region different from the target area compared to when the irradiation position is located in a second region between the target area and the first region.

A detection device according to an aspect of the present disclosure is a detection device configured to emit light toward a display surface to detect an irradiation position of the light, including an emission section configured to emit the light, a determination section configured to determine whether or not the irradiation position of the light in the display surface is located in a target area based on imaging data generated by imaging the display surface, and a direction control section configured to control an emission direction of the light to a direction of moving the irradiation position toward the target area when the determination section determines that the irradiation position is not located in the target area, wherein the direction control section sets an amount of movement of the irradiation position toward the target area by control of the emission direction of the light larger when the irradiation position is located in a first region different from the target area compared to when the irradiation position is located in a second region between the target area and the first region.

### BRIEF DESCRIPTION OF THE DRAWINGS

FIG. 1 is a diagram schematically showing a display device 1 according to a first embodiment.

FIG. 2 is a side view of the display device 1 viewed from a direction of the arrow P shown in FIG. 1.

FIG. 3 is a diagram showing an example of a first laser source unit 31a and a second laser source unit 31b.

FIG. 4 is a diagram showing a situation when an adjustment of a position of a first irradiation area L1 and an adjustment of a position of a second irradiation area L2 are completed.

FIG. 5 is a diagram showing an example of a reflecting body SS.

FIG. 6 is a diagram showing an example of the display device 1.

FIG. 7 is a diagram showing an example of a motion of a first irradiation position S1.

FIG. 8 is a flowchart for explaining an adjustment operation in an emission direction of a first light curtain La and an emission direction of a second light curtain Lb.

FIG. 9 is a flowchart for explaining the adjustment operation in the emission direction of the first light curtain La and the emission direction of the second light curtain Lb.

FIG. 10 is a diagram showing an example of an operation of the display device 1.

FIG. 11 is a diagram showing an example of an operation of the display device 1.

### DESCRIPTION OF AN EXEMPLARY EMBODIMENT

### A: First Embodiment

### A1: Outline of Display Device 1

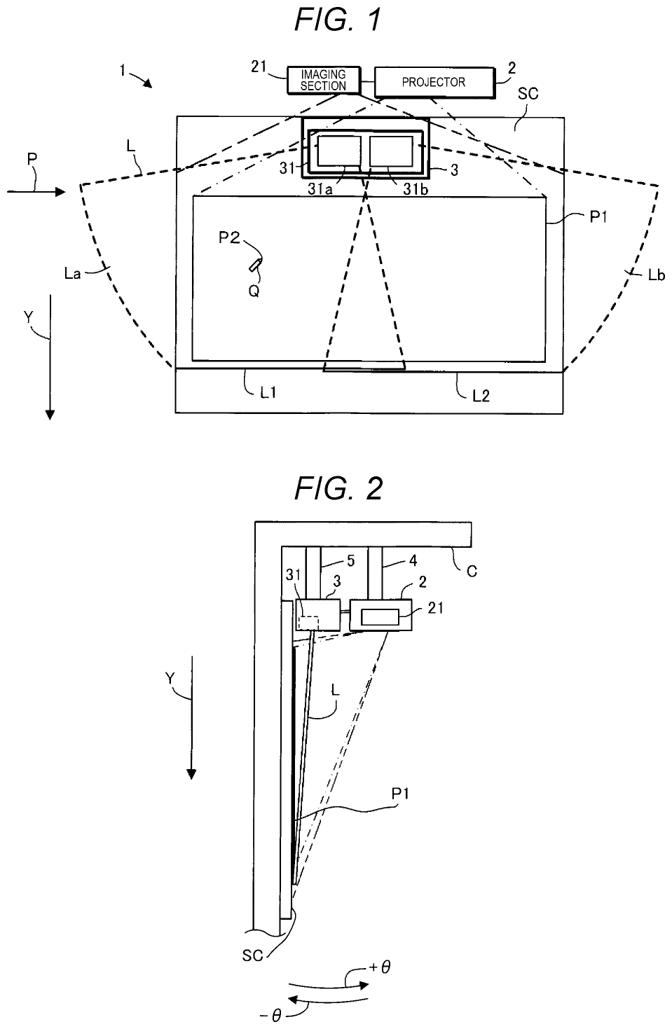

FIG. 1 is a diagram schematically showing a display device 1 according to a first embodiment. FIG. 2 is a side view of the display device 1 viewed from a direction of the arrow P shown in FIG. 1.

The display device 1 includes a projector 2, a light curtain generation device 3, and an imaging section 21. The imaging section 21 performs communication with the projector 2 with wire or wirelessly. Further, the imaging section 21 can be provided with a configuration included in the projector 2.

The projector 2 is installed on a ceiling C via a first support section 4. The projector 2 can also be installed in a part of the wall instead of the ceiling C. The projector 2 projects a projection image P1 on a screen SC to thereby display the projection image P1 on the screen SC. The screen SC is an example of a display surface. The display surface is not limited to the screen SC, but can also be a part of the wall or a door. When the screen SC is disposed so as to stand vertically, the vertical direction is defined as a Y direction.

The light curtain generation device 3 is installed on the ceiling C via a second support section 5. The light curtain generation device 3 can be installed in a part of the wall instead of the ceiling C. Further, the light curtain generation device 3 can be installed in a part of the screen SC.

The light curtain generation device 3 includes a laser source unit 31 for emitting a light curtain L formed of light in a planar fashion so that the light curtain L passes on at least a part of the screen SC. Here, the sentence that the light curtain L passes on at least a part of the screen SC means that the light curtain L at least passes on a projection area or an assumed projection area for the projection image P1 in the screen SC. Therefore, the sentence that the light curtain L passes on at least a part of the screen SC includes, for example, the fact that the light curtain L proceeds along the screen SC, and the fact that an end or the like of the screen SC is irradiated with the light curtain L after the light curtain L passes on the projection image P1 on the screen SC.

The light curtain L can be emitted in a different fashion instead of being emitted in a planar fashion. The light curtain L is the light in an infrared wavelength band. The light curtain L covers an area where the projection image P1 is projected in the screen SC. The light curtain L is the light shaped like a layer, and is set so as to be separated in a normal direction at a distance of several millimeters from an area of the screen SC on which the projection image P1 is projected.

The light curtain L is used for detecting a pointing position P2 on the projection image P1 to be touched with a pointing body Q such as a finger of a user, a rod, or a pen. In order to improve the detection accuracy of the pointing position P2, the light curtain L is set so as to decrease the distance from the area of the screen SC on which the projection image P1 is projected. However, when making the distance too short, false detection is incurred depending on the surface state of the screen SC.

The light curtain L includes first light curtain La and second light curtain Lb. A part of the first light curtain La and a part of the second light curtain Lb overlap each other when viewed from a normal direction of the screen SC.

When the screen SC is disposed so as to stand vertically, the vertical direction is defined as the Y direction.

When the light curtain L is emitted in a downward direction from an upper part of the screen SC, the light curtain L is set so that a place lower than the projection image P1 is irradiated with the light curtain L in the screen SC. In FIG. 1, there are shown a place irradiated with the first light curtain La as a first irradiation area L1, and a place irradiated with the second light curtain Lb as a second irradiation area L2.

The laser source unit 31 includes a first laser source unit 31a for emitting the first light curtain La, and a second laser source unit 31b for emitting the second light curtain Lb. The first laser source unit 31a and the second laser source unit 31b are each an example of an emission section. The emission section is not limited to the first laser source unit 31a or the second laser source unit 31b, but can also be a unit for emitting the light curtain L using, for example, an LED.

The imaging section 21 is a camera provided with an optical system such as a lens, and an imaging element for converting the light collected by the optical system into an electric signal. The imaging element is a CCD (Charge Coupled Device) image sensor for receiving the light in, for example, an infrared region or a visible light region. The imaging element is not limited to the CCD image sensor, but can also be a CMOS (Complementary Metal Oxide Semiconductor) image sensor for receiving the light in, for example, the infrared region or the visible light region. To the imaging section 21, there is attached an infrared filter in order to receive reflected light of the light curtain L by an object such as the pointing body Q.

The imaging section 21 takes an image of the screen SC to generate imaging data. When a part of the light curtain L is reflected by the object such as the pointing body Q or the screen SC, the imaging data represents the reflected light of the light curtain L. The imaging section 21 outputs the imaging data to the projector 2.

The projector 2 detects a reflection position of the light curtain L using the imaging data. The reflection position is used as, for example, the pointing position P2 by the pointing body Q. The projector 2 changes the projection image P1, or projects an image representing a trajectory of the pointing position P2 on the screen SC in accordance with the pointing position P2 by the pointing body Q.

### A2: Example of First Laser Source Unit 31a and Second Laser Source Unit 31b

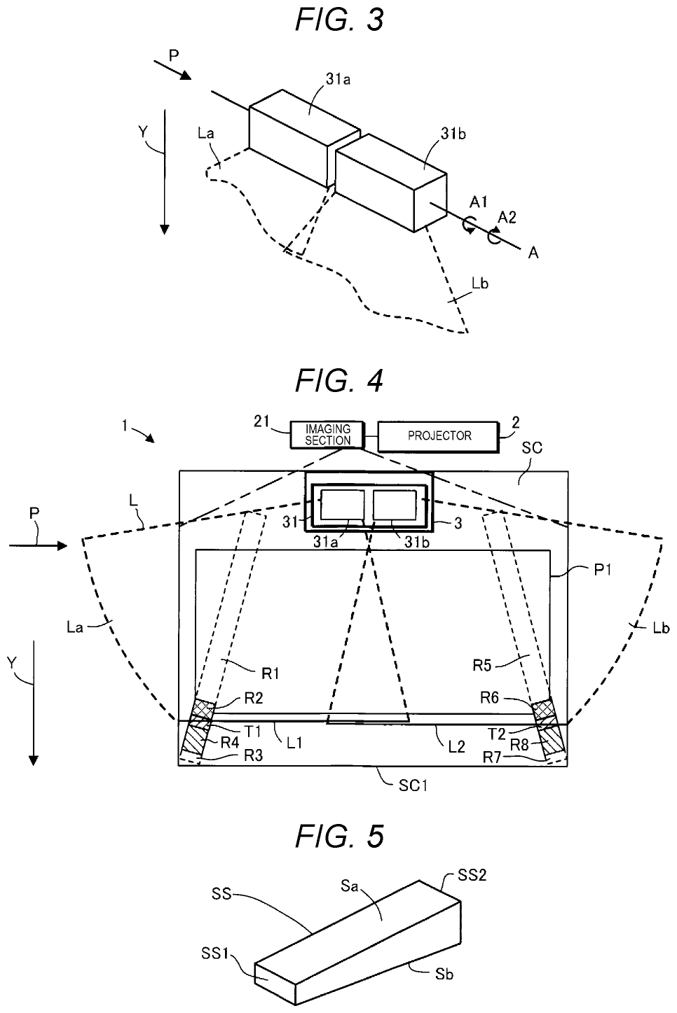

FIG. 3 is a diagram showing an example of the first laser source unit 31a and the second laser source unit 31b.

The first laser source unit 31a and the second laser source unit 31b each rotate in an A1 direction and an A2 direction around a rotational axis A. The rotational axis A is in a direction along the arrow P shown in FIG. 1. The first laser source unit 31a and the second laser source unit 31b rotate independently of each other.

Due to a rotation in the A1 direction of the first laser source unit 31a and a rotation in the A2 direction of the first laser source unit 31a, the first irradiation area L1 by the first light curtain La in the screen SC shown in FIG. 1 is changed.

Specifically, due to the rotation in the A1 direction of the first laser source unit 31a, the first irradiation area L1 comes closer to the first laser source unit 31a. In contrast, due to the rotation in the A2 direction of the first laser source unit 31a, the first irradiation area L1 gets away from the first laser source unit 31a.

Further, due to a rotation in the A1 direction of the second laser source unit 31b and a rotation in the A2 direction of the second laser unit 31a, the second irradiation area L2 by the second light curtain Lb in the screen SC is changed. The relationship between the rotation of the second laser source unit 31b and the moving direction of the second irradiation area L2 is substantially the same as the relationship between the rotation of the first laser source unit 31a and the moving direction of the first irradiation area L1.

### A3: Adjustment of Irradiation Area Between First Light Curtain La and Second Light Curtain Lb

The irradiation area of the light curtain L is adjusted as shown in FIG. 1 and FIG. 2.

The projector 2 locates a part of the first irradiation area L1 in a first target area T1 to be a target of the first light curtain La, and at the same time, locates a part of the second irradiation area L2 in a second target area T2 to be a target of the second light curtain Lb as shown in FIG. 4 using the imaging data generated by the imaging section 21. The first target area T1 and the second target area T2 are also set below a lower end of the projection area or the assumed projection area of the projection image P1 so that the light curtain L constituted by the first light curtain La and the second light curtain Lb covers the projection area of the projection image P1. The lower end of the projection area or the assumed projection area of the projection image P1 is an end on the opposite side to the side on which the laser source unit 31 of the projection image P1 is disposed. The first target area T1 is an example of the target area. The second target area T2 is another example of the target area.

The positions of the first target area T1 and the second target area T2 are set in the projector 2 in advance. For example, information representing the positions of the first target area T1 and the second target area T2 is input by the user to the projector 2. FIG. 4 shows a situation when an adjustment of the position of the first irradiation area L1 and an adjustment of the position of the second irradiation area L2 are completed. In FIG. 4, as areas when performing the adjustments, there are shown a first area R1, a second area R2, a third area R3, and a fourth area R4 which are areas on the periphery of the first target area T1, and a fifth area R5, a sixth area R6, a seventh area R7, and an eighth area R8 which are areas on the periphery of the second target area T2.

It should be noted that it is possible to install a reflecting body SS shown in FIG. 5 in the first target area T1 and the areas in the periphery thereof, specifically the first target area T1, the second area R2, and the fourth area R4 so that the first irradiation area L1 becomes easy to be imaged by the imaging section 21. The reflecting body SS has a configuration in which the reflected light of the light curtain L is easy to be reflected toward the imaging section 21.

The second area R2 is located between the first area R1 which is distant from the first target area T1 and the first target area T1. The fourth area R4 is located between the third area R3 which is distant from the first target area T1 and the first target area T1. The first target area T1 is located between the second area R2 and the fourth area R4.

The first area R1, the second area R2, the first target area T1, the fourth area R4, and the third area R3 are disposed in this order in the Y direction shown in FIG. 4. The Y direction is, for example, a vertical direction. It should be noted that the third area R3, the fourth area R4, the first target area T1, the second area R2, and the first area R1 can also be disposed in the reverse order in the Y direction shown in FIG. 4.

The size and the shape of each of the first area R1, the second area R2, the first target area T1, the fourth area R4, and the third area R3 are not limited to the size and the shape shown in FIG. 4, but can arbitrarily be changed.

The positions of the first area R1, the second area R2, the third area R3, and the fourth area R4 are set in the projector 2 in advance. For example, information representing the positions of the first area R1, the second area R2, the third area R3, and the fourth area R4 is input by the user to the projector 2.

The first area R1 is an example of a first region. When the first area R1 is the first region, the second area R2 is defined as a second region. The third area R3 is another example of the first region. When the third area R3 is the first region, the fourth area R4 is defined as the second region.

The reflecting body SS has a surface Sa capable of reflecting the light curtain L. The surface Sa is tilted with respect to a bottom surface Sb of the reflecting body SS. The height in one end SS1 of the reflecting body SS is lower than the height in the other end SS2 of the reflecting body SS. Therefore, when the reflecting body SS is installed in an area straddling the second area R2, the first target area T1, and the fourth area R4 so that the one end SS1 becomes closer to the light curtain generation device 3 than the other end SS2 in the Y direction, the light curtain L with which any one of the second area R2, the first target area T1, and the fourth area R4 is irradiated becomes easy to be reflected toward the imaging section 21. Therefore, the imaging section 21 becomes easy to image the reflected light of the light curtain L. It should be noted that the size and the shape of the reflecting body SS are not limited to the size and the shape shown in FIG. 5, but can arbitrarily be changed.

Further, it is possible to install the reflecting body SS shown in FIG. 5 in the second target area T2 and the areas in the periphery thereof, specifically the second target area T2, the sixth area R6, and the eighth area R8 so that the second irradiation area L2 becomes easy to be imaged by the imaging section 21.

The sixth area R6 is located between the fifth area R5 which is distant from the second target area T2 and the second target area T2. The eighth area R8 is located between the seventh area R7 which is distant from the second target area T2 and the second target area T2. The second target area T2 is located between the sixth area R6 and the eighth area R8.

The seventh area R7, the eighth area R8, the second target area T2, the sixth area R6, and the fifth area R5 are disposed in series in this order in the Y direction. It should be noted that the seventh area R7, the eighth area R8, the second target area T2, the sixth area R6, and the fifth area R5 can be disposed in the reverse order in the Y direction.

The size and the shape of each of the fifth area R5, the sixth area R6, the first target area T1, the eighth area R8, and the seventh area R7 are not limited to the size and the shape shown in FIG. 4, but can arbitrarily be changed.

The positions of the fifth area R5, the sixth area R6, the seventh area R7, and the eighth area R8 are set in the projector 2 in advance. For example, information representing the positions of the fifth area R5, the sixth area R6, the seventh area R7, and the eighth area R8 is input by the user to the projector 2.

The fifth area R5 is another example of the first region. When the fifth area R5 is the first region, the sixth area R6 is defined as the second region. The seventh area R7 is another example of the first region. When the seventh area R7 is the first region, the eighth area R8 is defined as the second region.

When the reflecting body SS is installed in an area straddling the sixth area R6, the second target area T2, and the eighth area R8 so that the one end SS1 becomes closer to the light curtain generation device 3 than the other end SS2 in the Y direction, the light curtain L with which any one of the sixth area R6, the second target area T2, and the eighth area R8 is irradiated becomes easy to be reflected toward the imaging section 21. Therefore, the imaging section 21 becomes easy to image the reflected light of the light curtain L.

It should be noted that an image representing the place where the reflecting body SS should be installed can be projected by the projector 2 on the screen SC. For example, the projector 2 projects an installation support image showing the area straddling the second area R2, the first target area T1, and the fourth area R4, and the area straddling the sixth area R6, the second target area T2, and the eighth area R8 on the screen SC.

The projector 2 identifies the area straddling the second area R2, the first target area T1, and the fourth area R4 using the information representing the position of the first target area T1 and information representing the positions of the first area R1, the second area R2, the third area R3, and the fourth area R4.

The projector 2 identifies the area straddling the sixth area R6, the second target area T2, and the eighth area R8 using the information representing the position of the second target area T2 and information representing the positions of the fifth area R5, the sixth area R6, the seventh area R7, and the eighth area R8.

When the installation support image is projected on the screen SC, the installation support image can support the installation operation by the user to install the reflecting body SS, and can therefore reduce time and effort of the installation operation by the user.

### A4: Example of Display Device 1

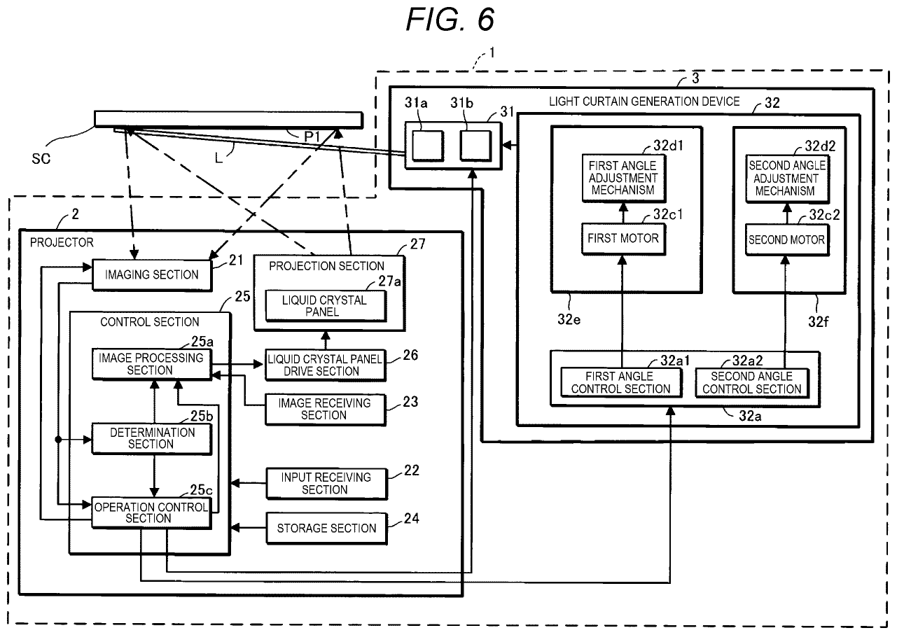

FIG. 6 is a diagram showing an example of the display device 1.

The projector 2 includes an input receiving section 22, an image receiving section 23, a storage section 24, a control section 25, a liquid crystal panel drive section 26, and a projection section 27. Further, the imaging section 21 is included in the projector 2. The light curtain generation device 3 includes an emission control section 32 for controlling the laser source unit 31 in addition to the laser source unit 31. The emission control section 32 controls an emission angle of the first light curtain La with respect to the screen SC and an emission angle of the second light curtain Lb with respect to the screen SC.

The emission angle of the first light curtain La with respect to the screen SC is hereinafter simply referred to as the “emission angle of the first light curtain La.” The emission angle of the second light curtain Lb with respect to the screen SC is hereinafter simply referred to as the “emission angle of the second light curtain Lb.”

In the display device 1, the constituents except the liquid crystal panel drive section 26 and the projection section 27 become an example of a detection device.

The input receiving section 22 includes, for example, a variety of operation buttons, operation keys, or a touch panel for receiving input and so on from the user. The input receiving section 22 can also be a remote controller for transmitting information input from the user to the projector 2 wirelessly or with wire. In this case, the projector 2 is provided with a receiver section for receiving the information transmitted by the remote controller. The remote controller is provided with a variety of operation buttons, operation keys, or a touch panel for receiving the input from the user.

The image receiving section 23 receives an image signal representing an image via, for example, an image input terminal. The image receiving section 23 outputs the image signal to the control section 25.

The storage section 24 is a computer-readable recording medium. The storage section 24 is provided with, for example, a RAM (Random Access Memory), a ROM (Read Only Memory), and an EEPROM (Electrically Erasable Programmable Read Only Memory). The storage section 24 stores a variety of types of information and programs to be processed by the control section 25.

For example, the storage section 24 stores position information representing respective positions of the first target area T1, second target area T2, and the first area R1 through the eighth area R8.

The control section 25 is formed of, for example, a single processor or a plurality of processors. Citing an example, the control section 25 is formed of a single CPU (Central Processing Unit) or a plurality of CPUs. Some or all of the functions of the control section 25 can also be configured by a circuit such as a DSP (Digital Signal Processor), an ASIC (Application Specific Integrated Circuit), a PLD (Programmable Logic Device), or an FPGA (Field Programmable Gate Array). The control section 25 executes a plurality of types of processing in parallel or in sequence.

The control section 25 retrieves the program from the storage section 24 and then executes the program to thereby realize an image processing section 25a, a determination section 25b, and an operation control section 25c. All or some of the image processing section 25a, the determination section 25b, and the operation control section 25c can be formed of a circuit such as an FPGA, in other words, hardware.

The image processing section 25a performs image processing on the image signal received from the image receiving section 23 to thereby generate image information.

The image processing executed by the image processing section 25a includes, for example, a geometric correction process for correcting a keystone distortion of the image to be projected by the projection section 27. The image processing to be executed by the image processing section 25a can be image processing which does not include the geometric correction process. For example, the image processing to be executed by the image processing section 25a can include a gamma correction process without including the geometric correction process. Further, the image processing to be executed by the image processing section 25a can include the geometric correction process and the gamma correction process.

The liquid crystal panel drive section 26 applies a drive voltage corresponding to the image information input from the image processing section 25a to each pixel of a liquid crystal panel 27a.

The projection section 27 projects the projection image P1 on the screen SC to thereby display the projection image P1 on the screen SC. The projection section 27 is an example of a display section. Here, the display section does not include the screen SC.

The projection section 27 includes a light source not shown and a reflector not shown for reflecting light emitted by the light source toward the liquid crystal panel 27a. The light source is, for example, a discharge type light source lamp formed of a super-high pressure mercury lamp, a metal halide lamp, or the like. The light source is not limited to the lamp, but can also be an LED (Light Emitting Diode) light source, a laser source, or the like.

The liquid crystal panel 27a is an example of a light modulation device. Each pixel of the liquid crystal panel 27a modulates the light reflected by the reflector in accordance with the drive voltage applied by the liquid crystal panel drive section 26 to thereby generate light representing the image corresponding to the image information.

The projection section 27 projects the image light generated by the liquid crystal panel 27a on the screen SC through a projection lens not shown as the projection image P1. The projection image P1 is taken by, for example, the imaging section 21.

The determination section 25b receives imaging data generated by the imaging section 21. The imaging data represents the reflected light reflected by the pointing body Q or the screen SC out of the light curtain L. The determination section 25b identifies the reflection position of the light curtain L based on the imaging data.

In a mode of identifying the position of the pointing body Q using the light curtain L, the determination section 25b identifies the reflection position of the light curtain L as the position of the pointing body Q based on the imaging data.

Further, in a mode of identifying the reflection position of the light curtain L in the screen SC, namely the irradiation position with the light curtain L in the screen SC, the determination section 25b identifies the irradiation position with the light curtain L in the screen SC based on the imaging data. The mode of identifying the irradiation position with the light curtain Lin the screen SC is used when performing an installation adjustment of the light curtain generation device 3.

Moreover, the determination section 25b identifies a first irradiation position S1 as the position of the first irradiation area L1, and a second irradiation position S2 as the position of the second irradiation area L2 based on the imaging data. The first irradiation position S1 is an example of an irradiation position. The second irradiation position S2 is another example of the irradiation position.

The determination section 25b identifies the position of the first irradiation area L1 in the Y direction as the first irradiation position S1.

For example, the determination section 25b identifies a barycentric position of the first irradiation area L1 in the Y direction as the first irradiation position S1 based on the imaging data generated in the situation in which the first light curtain La is emitted while the second light curtain Lb is not emitted.

Here, when the reflecting body SS is installed, the reflected light by the reflecting body SS out of the reflected light of the first light curtain La is easier to be imaged than the rest of the reflected light, and therefore becomes high in contribution rate in identifying the first irradiation position S1. Therefore, it is possible to improve the identification accuracy of the first irradiation position S1.

Further, the determination section 25b identifies a barycentric position of the second irradiation area L2 in the Y direction as the second irradiation position S2 based on the imaging data generated in the situation in which the second light curtain Lb is emitted while the first light curtain La is not emitted.

Further, the determination section 25b determines whether or not the first irradiation position S1 is located in the first target area T1 using position information stored in the storage section 24. Here, the first irradiation position S1 is defined only by the position in the Y direction. Therefore, the sentence that the first irradiation position S1 is located in a certain area means that the first irradiation position S1 is located in a region in the Y direction of that area.

Further, the determination section 25b determines whether or not the second irradiation position S2 is located in the second target area T2 using the position information. The second irradiation position S2 is defined only by the position in the Y direction similarly to the first irradiation position S1. Therefore, the sentence that the second irradiation position S2 is located in a certain area means that the second irradiation position S2 is located in a region in the Y direction of that area.

The operation control section 25c is an example of a direction control section. The operation control section 25c controls the emission control section 32 based on a determination result by the determination section 25b. For example, when the first irradiation position S1 is not located in the first target area T1, the operation control section 25c controls the emission direction of the first light curtain La to a direction of moving the first irradiation position S1 toward the first target area T1.

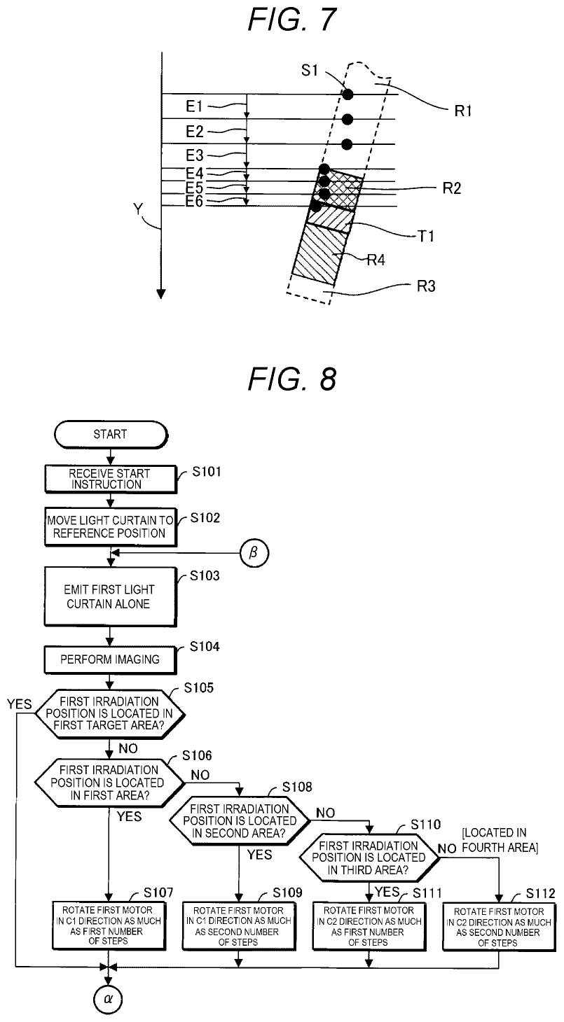

Citing an example, as shown in FIG. 7, when the first irradiation position S1 is located in the first area R1, the operation control section 25c sets the amount of movement E1, E2, and E3, which are amount of movement of the first irradiation position S1 toward the first target area T1 by the control of the emission direction of the first light curtain La, larger compared to when the first irradiation position S1 is located in the second area R2.

In other words, the operation control section 25c sets the amount of movement E1, E2, and E3 which are amount of movement of the first irradiation position S1 toward the first target area T1 by the control of the emission direction of the first light curtain La when the first irradiation position S1 is located in the first area R1 larger than the amount of movement E4, E5, and E6 which are amount of movement of the first irradiation position S1 toward the first target area T1 by the control of the emission direction of the first light curtain La when the first irradiation position S1 is located in the second area R2.

Further, when the second irradiation position S2 is not located in the second target area T2, the operation control section 25c controls the emission direction of the second light curtain Lb to a direction of moving the second irradiation position S2 toward the second target area T2. For example, when the second irradiation position S2 is located in the fifth area R5, the operation control section 25c sets the amount of movement of the second irradiation position S2 toward the second target area T2 by the control of the emission direction of the second light curtain Lb larger compared to when the second irradiation position S2 is located in the sixth area R6.

The operation control section 25c controls the emission control section 32 using a control signal S to thereby control the emission direction of the first light curtain La and the emission direction of the second light curtain Lb.

The control signal S is a signal for controlling rotations of motors included in the emission control section 32, specifically, a first motor 32c1 for adjusting the emission angle of the first light curtain La, and a second motor 32c2 for adjusting the emission angle of the second light curtain Lb. Specifically, the control signal S represents the number of rotations and the rotational direction of the first motor 32c1, and the number of rotations and the rotational direction of the second motor 32c2. The operation control section 25c stores the history of the control signal S in the storage section 24.

The first laser source unit 31a is, for example, a unit having optical system members such as a collimator lens and a Powell lens attached to one LD (Laser Diode) or a plurality of LDs.

The second laser source unit 31b has substantially the same configuration as the first laser source unit 31a except the point that the second light curtain Lb is emitted instead of the first light curtain La.

The emission control section 32 includes a motor control section 32a, a first angle adjustment section 32e, and a second angle adjustment section 32f.

The motor control section 32a includes a first angle control section 32a1 for controlling the first angle adjustment section 32e, and a second angle control section 32a2 for controlling the second angle adjustment section 32f.

The first angle control section 32a1 controls the first motor 32c1 in accordance with the number of rotations and the rotational direction of the first motor 32c1 out of the information represented by the control signal S.

The second angle control section 32a2 controls the second motor 32c2 in accordance with the number of rotations and the rotational direction of the second motor 32c2 out of the information represented by the control signal S.

The first angle adjustment section 32e adjusts the emission angle of the first light curtain La. The first angle adjustment section 32e includes the first motor 32c1 and a first angle adjustment mechanism 32d1. The first motor 32c1 is a stepping motor.

The first angle adjustment mechanism 32d1 changes the emission angle of the first light curtain La in accordance with the rotation of the first motor 32c1. Specifically, the first angle adjustment mechanism 32d1 rotates the first laser source unit 31a in the A1 direction and the A2 direction shown in FIG. 3 in accordance with the rotation of the first motor 32c1. When the first laser source unit 31a rotates in the A1 direction, the first light curtain La rotates in a −θ direction shown in FIG. 2. When the first laser source unit 31a rotates in the A2 direction, the first light curtain La rotates in a +θ direction shown in FIG. 2. The +θ direction is a direction in which the first light curtain La gets away from the screen SC, and the −θ direction is a direction in which the first light curtain La comes closer to the screen SC.

The second angle adjustment section 32f adjusts the emission angle of the second light curtain Lb. The second angle adjustment section 32f includes the second motor 32c2 and a second angle adjustment mechanism 32d2. The second motor 32c2 is a stepping motor.

The second angle adjustment mechanism 32d2 changes the emission angle of the second light curtain Lb in accordance with the rotation of the second motor 32c2. Specifically, the second angle adjustment mechanism 32d2 rotates the second laser source unit 31b in the A1 direction and the A2 direction in accordance with the rotation of the second motor 32c2. When the second laser source unit 31b rotates in the A1 direction, the second light curtain Lb rotates in the −θ direction. When the second laser source unit 31b rotates in the A2 direction, the second light curtain Lb rotates in the +θ direction.

### A5: Operation Example

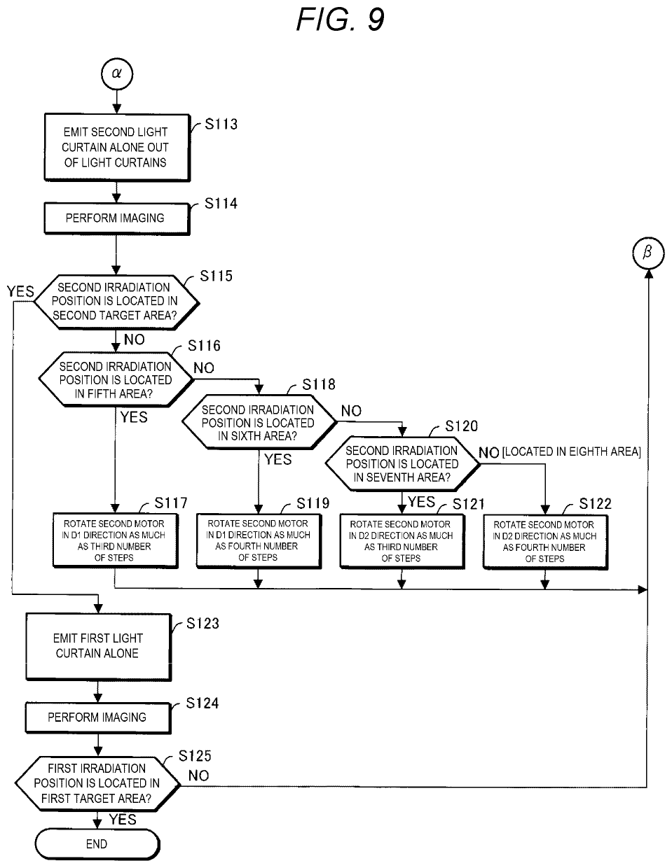

FIG. 8 and FIG. 9 are each a flowchart for explaining the adjustment operation in the emission direction of the first light curtain La and the emission direction of the second light curtain Lb. Hereinafter, it is assumed that the flowchart represents the mode of identifying the irradiation position of the light curtain L in the screen SC, and the pointing body Q is not located on the screen SC.

Hereinafter, it is assumed that when the first motor 32c1 rotates in a C1 direction, the first laser source unit 31a rotates in the A2 direction, and thus, the first light curtain La rotates in the +θ direction as shown in FIG. 2 and FIG. 3, and when the first motor 32c1 rotates in a C2 direction opposite to the C1 direction, the first laser source unit 31a rotates in the A1 direction, and thus, the first light curtain La rotates in the −θ direction.

Further, it is assumed that when the second motor 32c2 rotates in a D1 direction, the second laser source unit 31b rotates in the A2 direction, and thus, the second light curtain Lb rotates in the +θ direction as shown in FIG. 2 and FIG. 3, and when the second motor 32c2 rotates in a D2 direction opposite to the D1 direction, the second laser source unit 31b rotates in the A1 direction, and thus, the second light curtain Lb rotates in the −θ direction.

The maximum displacement position toward the −θ direction of each of the first light curtain La and the second light curtain Lb is referred to as a “reference position.” It should be noted that the reference position is not limited to the maximum displacement position toward the −θ direction of each of the first light curtain La and the second light curtain Lb, but can also be an arbitrary position of each of the first light curtain La and the second light curtain Lb. For example, the maximum displacement position toward the −θ direction of each of the first light curtain La and the second light curtain Lb is the closest position to the first laser source unit 31a in the first irradiation area L1, and the closest position to the second laser source unit 31b in the second irradiation area L2. Further, for example, when the size or the like of the projection area of the projection image P1 is known, it is possible to set a smaller displacement position than the maximum displacement position toward the −θ direction of each of the first light curtain La and the second light curtain Lb as the reference position.

The step S103 through the step S112 shown in FIG. 8 correspond to a process of adjusting the emission direction of the first light curtain La. The step S113 through the step S122 shown in FIG. 9 correspond to a process of adjusting the emission direction of the second light curtain Lb.

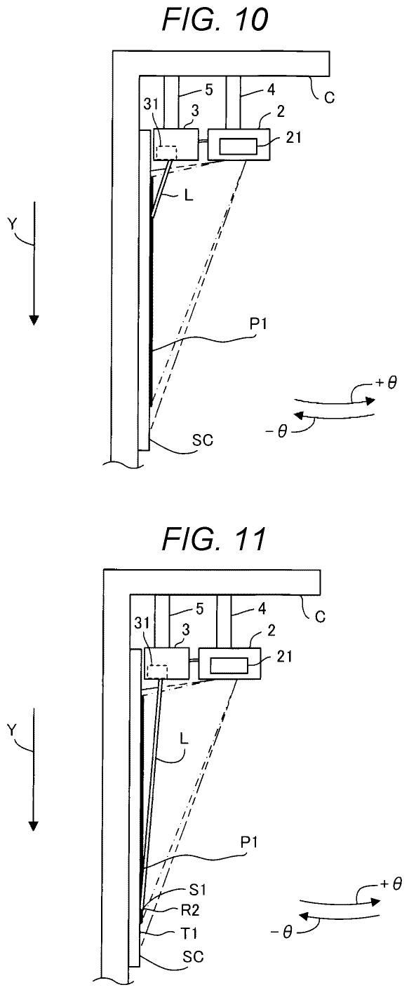

When the input receiving section 22 receives a start instruction representing a start of adjustment of the emission direction of the light curtain L in the step S101, the operation control section 25c controls the emission control section 32 in the step S102 using the control signal S to thereby move each of the first light curtain La and the second light curtain Lb to the reference position as shown in FIG. 10.

Subsequently, in the step S103, the operation control section 25c controls the laser source unit 31 to thereby emit only the first light curtain La without emitting the second light curtain Lb.

Subsequently, the operation control section 25c outputs the imaging instruction to the imaging section 21.

Subsequently, in the step S104, the imaging section 21 executes imaging of the screen SC in accordance with the imaging instruction. The imaging section 21 outputs the imaging data generated by imaging to the determination section 25b and the operation control section 25c.

Subsequently, in the step S105, the determination section 25b determines whether or not the first irradiation position S1 is located in the first target area T1 based on the imaging data.

As an example of the step S105, the determination section 25b firstly identifies the first irradiation area L1 based on the imaging data. The first irradiation area L1 is an area irradiated with the first light curtain La in the screen SC. Therefore, in the imaging data, the first irradiation area L1 is higher in luminance than other areas. Therefore, the determination section 25b identifies a portion having the luminance no lower than an area threshold value in the imaging data as the first irradiation area L1.

Subsequently, the determination section 25b identifies the barycentric position of the first irradiation area L1 in the Y direction as the first irradiation position S1. Subsequently, the determination section 25b identifies the position of the first target area T1 using the position information stored in the storage section 24. Subsequently, the determination section 25b determines whether or not the first irradiation position S1 is located in the first target area T1.

The determination section 25b outputs the determination result and the first irradiation position S1 to the operation control section 25c.

When the determination section 25b determines that the first irradiation position S1 is not located in the first target area T1 in the step S105, the operation control section 25c determines whether or not the first irradiation position S1 is located in the first area R1 in the step S106.

As an example of the step S106, the operation control section 25c firstly identifies the position of the first area R1 using the position information stored in the storage section 24. Subsequently, the operation control section 25c determines whether or not the first irradiation position S1 is located in the first area R1.

When it is determined in the step S106 that the first irradiation position S1 is not located in the first area R1, the operation control section 25c outputs the control signal S instructing an operation of rotating the first motor 32c1 in the C1 direction as much as a first number of steps to the emission control section 32.

Subsequently, in the step S107, the first angle control section 32a1 of the emission control section 32 rotates the first motor 32c1 in the C1 direction as much as the first number of steps in accordance with the control signal S. Therefore, the first light curtain La rotates in the +θ direction. Therefore, the first irradiation area L1 moves toward the first target area T1. Subsequently, the step S113 described later is executed.

When it is determined in the step S106 that the first irradiation position S1 is not located in the first area R1, the operation control section 25c determines whether or not the first irradiation position S1 is located in the second area R2 in the step S108.

As an example of the step S108, the operation control section 25c firstly identifies the position of the second area R2 using the position information stored in the storage section 24. Subsequently, the operation control section 25c determines whether or not the first irradiation position S1 is located in the second area R2.

When it is determined in the step S108 that the first irradiation position S1 is located in the second area R2, for example, when the positional relationship between the first irradiation position S1 and the second area R2 is in the state shown in FIG. 1, the operation control section 25c outputs the control signal S instructing an operation of rotating the first motor 32c1 in the C1 direction as much as a second number of steps to the emission control section 32.

The second number of steps is smaller than the first number of steps.

Furthermore, the second number of steps is set in advance so that the amount of movement of the first irradiation position S1 toward the first target area T1 in accordance with the rotation in the C1 direction as much as the second number of steps of the first motor 32c1 becomes smaller than the amount of movement of the first irradiation position S1 toward the first target area T1 in accordance with the rotation in the C1 direction as much as the first number of steps of the first motor 32c1.

Subsequently, in the step S109, the first angle control section 32a1 of the emission control section 32 rotates the first motor 32c1 in the C1 direction as much as the second number of steps in accordance with the control signal S. Therefore, the first light curtain La rotates in the +e direction. Therefore, the first irradiation position S1 moves toward the first target area T1.

After the step S109, the step S113 described later is executed.

When it is determined in the step S108 that the first irradiation position S1 is not located in the second area R2, the operation control section 25c determines whether or not the first irradiation position S1 is located in the third area R3 in the step S110.

As an example of the step S110, the operation control section 25c firstly identifies the position of the third area R3 using the position information stored in the storage section 24. Subsequently, the operation control section 25c determines whether or not the first irradiation position S1 is located in the third area R3.

When it is determined in the step S110 that the first irradiation position S1 is located in the third area R3, the operation control section 25c outputs the control signal S instructing an operation of rotating the first motor 32c1 in the C2 direction as much as the first number of steps to the emission control section 32.

Subsequently, in the step S111, the first angle control section 32a1 of the emission control section 32 rotates the first motor 32c1 in the C2 direction as much as the first number of steps in accordance with the control signal S. Therefore, the first light curtain La rotates in the −θ direction. Therefore, the first irradiation position S1 moves toward the first target area T1. Subsequently, the step S113 described later is executed.

When it is determined in the step S110 that the first irradiation position S1 is not located in the third area R3, the operation control section 25c determines that the first irradiation position S1 is located in the fourth area R4. Subsequently, the operation control section 25c outputs the control signal S instructing an operation of rotating the first motor 32c1 in the C2 direction as much as the second number of steps to the emission control section 32.

Subsequently, in the step S112, the first angle control section 32a1 of the emission control section 32 rotates the first motor 32c1 in the C2 direction as much as the second number of steps in accordance with the control signal S. Therefore, the first light curtain La rotates in the −θ direction. Therefore, the first irradiation position S1 moves toward the first target area T1. Subsequently, the step S113 described later is executed.

When the determination section 25b determines that the first irradiation position S1 is located in the first target area T1 in the step S105, the step S106 through the step S112 are skipped, and the step S113 is executed.

In the step S113, the operation control section 25c controls the laser source unit 31 to thereby emit only the second light curtain Lb without emitting the first light curtain La.

The description of the step S114 through the step S122 to be executed after the step S113 will be made by performing the following replacements on the description of the step S104 through the step S112 described above. The “first irradiation position S1” is replaced with the “second irradiation position S2.” The “first target area T1” is replaced with the “second target area T2.” The “first area R1” is replaced with the “fifth area R5.” The “second area R2” is replaced with the “sixth area R6.” The “third area R3” is replaced with the “seventh area R7.” The “fourth area R4” is replaced with the “eighth area R8.” The “first motor 32c1” is replaced with the “second motor 32c2.” The “first angle control section 32a1” is replaced with the “second angle control section 32a2.” The “first number of steps” is replaced with the “third number of steps.” The “second number of steps” is replaced with the “fourth number of steps.” The “C1 direction” is replaced with the “D1 direction.” The “C2 direction” is replaced with the “D2 direction.”

It should be noted that when the second irradiation position S2 is located in the second target area T2 in the step S115, the step S123 through the step S125 are executed. The processing contents of the step S123 through the step S125 are the same as the processing contents of the step S103 through the step S105.

When the first irradiation position S1 is not located in the first target area T1 in the step S125, the process returns to the step S103. Further, after terminating each of the step S117, the step S119, the step S121, and the step S122, the process also returns to the step S103.

In contrast, when it is determined that the first irradiation position S1 is located in the first target area T1 in the step S125 after it has been determined that the second irradiation position S2 is located in the second target area T2 in the step S115, for example, when the positional relationship between first light curtain La and the first target area T1 and the positional relationship between the second light curtain Lb and the second target area T2 are in the positional relationship shown in FIG. 4, the operation control section 25c terminates the process shown in FIG. 8 and FIG. 9. Thus, the automatic adjustment in installing the light curtain generation device 3 is completed.

It should be noted that it is possible for the operation control section 25c to control the emission control section 32 using the control signal S so that each of the first irradiation position S1 and the second irradiation position S2 is located at a lower end SC1 of the screen SC shown in FIG. 4 after determining that the first irradiation position S1 is located in the first target area T1 in the step S125.

For example, the storage section 24 stores distance information representing a distance in the Y direction from the first target area T1 to the lower end SC1 of the screen SC and a distance in the Y direction from the second target area T2 to the lower end SC1. The operation control section 25c generates the control signal S for moving each of the first irradiation position S1 and the second irradiation position S2 to the lower end SC1 using the distance information, and then outputs the control signal S to the emission control section 32.

In this case, it is also possible for the first target area T1 and the second target area T2 to be set above the lower end of the projection area or the assumed projection area of the projection image P1.

### A6: Conclusion of First Embodiment

The method of controlling the emission direction of the light and the display device 1 according to the present embodiment described above include the following aspects.

The first laser source unit 31a emits the first light curtain La.

The determination section 25b performs the determination process of determining whether or not the first irradiation position S1 with respect to the first light curtain La in the screen SC is located in the first target area T1 based on the imaging data generated by imaging the screen SC.

When the determination section 25b determines that the first irradiation position S1 is not located in the first target area T1, the operation control section 25c performs the control process of controlling the emission direction of the first light curtain La to a direction of moving the first irradiation position S1 toward the first target area T1.

When the first irradiation position S1 is located in the first area R1, the operation control section 25c sets the amount of movement of the first irradiation position S1 toward the first target area T1 by the control of the emission direction of the first light curtain La larger compared to when the first irradiation position S1 is located in the second area R2.

According to this aspect, the time until the first irradiation position S1 reaches the first target area T1 can be shortened compared to when the amount of movement of the first irradiation position S1 when the first irradiation position S1 is not located in the first target area T1 is fixed to the amount of movement of the first irradiation position S1 when the first irradiation position S1 is located in the second area R2. In other words, in the adjustment performed when installing the light curtain generation device 3, the time necessary for the adjustment can be shortened without degrading the adjustment accuracy.

Further, it is possible to make the first irradiation position S1 reach the first target area T1 with a simple process without performing a complicated calculation process as in the configuration of, for example, calculating the distance from the first irradiation position S1 to the first target area T1, and then moving the first irradiation position S1 based on the calculation result.

The determination process in the determination section 25b and the control process in the operation control section 25c are repeatedly performed until the first irradiation position S1 is located in the first target area T1. Therefore, by performing each of the determination process and the control process a plurality of times, it becomes possible to locate the first irradiation position S1 in the first target area T1.

The operation control section 25c controls the posture of the first laser source unit 31a to thereby control the emission direction of the first light curtain La. Therefore, it is possible to easily change the emission direction of the first light curtain La.

### B: Modified Examples

Some aspects of the modifications of the embodiment illustrated hereinabove will be illustrated blow. It is also possible to arbitrarily combine two or more aspects arbitrarily selected from the following illustrations with each other within a range in which the aspects do not conflict with each other.

### B1: First Modified Example

In the embodiment described above, it is possible for the operation control section 25c to control both or either one of the rotational speed of the first motor 32c1 and the rotational speed of the second motor 32c2. For example, the operation control section 25c shows the rotational speed of the first motor 32c1 and the rotational speed of the second motor 32c2 in the control signal S. The first angle control section 32a1 rotates the first motor 32c1 at the rotational speed of the first motor 32c1 represented by the control signal S. The second angle control section 32a2 rotates the second motor 32c2 at the rotational speed of the second motor 32c2 represented by the control signal S.

In this case, when the first irradiation position S1 is located in the second area R2, it is possible for the operation control section 25c to make the rotational speed of the first motor 32cl lower than when the first irradiation position S1 is located in the first area R1.

For example, the operation control section 25c controls the rotational speed of the first motor 32cl so that the moving speed of the first irradiation position S1 from the second area R2 toward the first target area T1 by the control of the emission direction of the first light curtain La becomes lower than the moving speed of the first irradiation position S1 from the first area R1 toward the first target area T1 by the control of the emission direction of the first light curtain La.

According to the first modified example, when the first irradiation position S1 is located in the second area R2 closer to the first target area T1 than the first area R1, it becomes possible to suppress the position shift of the first irradiation position S1 caused by an inertia of the rotation of the first motor 32cl or the like compared to when the first irradiation position S1 is located in the first area R1.

### B2: Second Modified Example

In the first embodiment and the first modified example, it is possible for the laser source unit 31 to have either one of the first laser source unit 31a and the second laser source unit 31b alone. In this case, either one of the first laser source unit 31a and the second laser source unit 31b included in the laser source unit 31 emits the light curtain L by itself.

### B3: Third Modified Example

In the first embodiment and the first and second modified examples, the amount of movement of the first irradiation position S1 toward the first target area T1 by the control of the emission direction of the first light curtain La when the first irradiation position S1 is located in the second area R2 is not limited to the amount of movement E4, E5, and E6 shown in FIG. 7. It should be noted that it is necessary to fulfill the condition that the amount of movement of the first irradiation position S1 toward the first target area T1 by the control of the emission direction of the first light curtain La when the first irradiation position S1 is located in the second area R2 is smaller than the amount of movement of the first irradiation position S1 toward the first target area T1 by the control of the emission direction of the first light curtain La when the first irradiation position S1 is located in the first area R1.

Further, the amount of movement of the first irradiation position S1 toward the first target area T1 by the control of the emission direction of the first light curtain La when the first irradiation position S1 is located in the first area R1 is not limited to the amount of movement E1, E2, and E3 shown in FIG. 7. It should be noted that it is necessary to fulfill the condition described above.

### B4: Fourth Modified Example

In the first embodiment and the first through third modified examples, it is possible for the operation control section 25c to directly control the first motor 32c1 and the second motor 32c2.

### B5: Fifth Modified Example

In the first embodiment and the first through fourth modified examples, two or more of the projector 2, the light curtain generation device 3, and the imaging section 21 can be integrated with each other and formed of hardware.

### B6: Sixth Modified Example

In the first embodiment and the first through fifth modified examples, the wavelength band of the light curtain L can be a wavelength band of visible light and so on.

### B7: Seventh Modified Example

In the first embodiment and the first through sixth modified examples, a variety of types of actuator can be used instead of the first motor 32c1, and a variety of types of actuator can be used instead of the second motor 32c2.

### B8: Eighth Modified Example

Although the liquid crystal panel 27a is used as an example of the light modulation device in the first embodiment and the first through seventh modified examples, the light modulation device is not limited to the liquid crystal panel, and can arbitrarily be changed. For example, it is also possible for the light modulation device to have a configuration using three reflective liquid crystal panels. Further, it is also possible for the light modulation device to have a configuration such as a system using three transmissive liquid crystal panels, a system using three digital mirror devices (DMD), or a system using a single digital mirror device. When using just one liquid crystal panel or DMD as the light modulation device, the members corresponding to the color separation optical system and the color combining optical system are unnecessary. Further, configurations which are different from either of the liquid crystal panel and the DMD, and are capable of modulating the light can be adopted as the light modulation device.

### B9: Ninth Modified Example

In the first embodiment and the first through eighth modified examples, it is possible to use a display such as an FPD (Flat Panel Display) instead of the screen SC and the projector 2. It is possible to install the display surface of the FPD so as to stand vertically, and to install a detection device in an upper part of, or above the FPD. The FPD is, for example, a liquid crystal display, a plasma display, or an organic EL (Electro Luminescence) display. When the FPD is used instead of the projector 2, the FPD can be an FPD used for an electronic blackboard or an electronic conference system.

What is claimed is:

1. A control method of controlling an emission direction of light emitted from an emission section toward a display surface to be executed by a detection device configured to include the emission section and detect an irradiation position of the light, the method comprising:
determining whether or not the irradiation position of the light in the display surface is located in a target area based on imaging data generated by imaging the display surface;
controlling the emission direction of the light to a direction of moving the irradiation position toward the target area when determining that the irradiation position is not located in the target area; and
setting an amount of movement of the irradiation position toward the target area by control of the emission direction of the light larger when the irradiation position is located in a first region different from the target area compared to when the irradiation position is located in a second region between the target area and the first region.

2. The control method according to claim 1, wherein
the determination and the control are repeated until the irradiation position is located in the target area.

3. The control method according to claim 1, wherein
moving speed of the irradiation position from the second region toward the target area by the control of the emission direction of the light is made lower than moving speed of the irradiation position from the first region toward the target area by the control of the emission direction of the light.

4. The control method according to claim 1, wherein
the emission direction of the light is controlled by controlling a posture of the emission section.

5. The control method according to claim 1, wherein
a reflecting body is installed in an area including the target area of the display surface, and
the irradiation position of the light in the display surface is detected in accordance with a reflection position of the light in the reflecting body based on the imaging data.

6. A detection device configured to emit light toward a display surface to detect an irradiation position of the light, comprising:
an emission section configured to emit the light;
a determination section configured to determine whether or not the irradiation position of the light in the display surface is located in a target area based on imaging data generated by imaging the display surface; and
a direction control section configured to control an emission direction of the light to a direction of moving the irradiation position toward the target area when the determination section determines that the irradiation position is not located in the target area, wherein
the direction control section sets an amount of movement of the irradiation position toward the target area by control of the emission direction of the light larger when the irradiation position is located in a first region different from the target area compared to when the irradiation position is located in a second region between the target area and the first region.

7. A display device comprising:
the detection device according to claim 6; and
a display section configured to display an image on the display surface.
